(19) United States
(12) Patent Application Publication
(10) Pub. No.: US 2026/0313675 A1
(43) Pub. Date: Oct. 8, 2026

(54) COMMUNICATION METHOD AND COMMUNICATION APPARATUS

(71) Applicant: HUAWEI TECHNOLOGIES CO., LTD., Shenzhen (CN)

(72) Inventors: Chenglong Jiang, Shanghai (CN); Xiaoyan Bi, Shanghai (CN); Yong Liu, Shanghai (CN); Xiaojun Xi, Shenzhen (CN)

(21) Appl. No.: 19/461,917

(22) Filed: Jan. 28, 2026

Related U.S. Application Data
(63) Continuation of application No. PCT/CN2023/110069, filed on Jul. 29, 2023.

(51) Int. Cl. H04W 72/541; H04B 15/02; H04B 17/345

(52) U.S. Cl. CPC H04W 72/541; H04B 15/02; H04B 17/345

(57) ABSTRACT

Embodiments of this application provide a communication method and a communication apparatus. The method includes: receiving a first signal, where the first signal includes a second signal and a third signal that causes interference to the second signal; and learning of, based on received indication information, a resource occupied by the third signal, so that the interference caused by the third signal can be accurately determined based on the resource occupied by the third signal. This helps accurately cancel the third signal from the first signal to obtain the second signal, to implement correct signal receiving and improve signal transmission quality.

### CROSS-REFERENCE TO RELATED APPLICATIONS

This application is a continuation of International Application No. PCT/CN2023/110069, filed on Jul. 29, 2023, the disclosure of which is hereby incorporated by reference in its entirety.

### TECHNICAL FIELD

This application relates to the field of communication technologies, for example, to a communication method and a communication apparatus.

### BACKGROUND

Over the past decades, a wireless communication system has undergone evolution and research from first generation analog communication to a 5th generation (5th generation, 5G) communication technology and a current 6th generation (6th generation, 6G) communication technology.

When a signal is sent between devices, the device is able to be interfered by another signal. How to enable a receiving device to accurately cancel interference, to implement correct signal receiving and improve signal transmission quality needs to be resolved.

### SUMMARY

At least one embodiment provides a communication method and a communication apparatus, to improve signal transmission quality.

A first aspect of at least one embodiment provides a communication method. The method is able to be performed by a first apparatus, and the first apparatus is a terminal device or a module (for example, a chip) used in the terminal device. The method includes: receiving a first signal, where the first signal includes a second signal and a third signal, and the third signal is a signal that causes interference to the second signal; receiving indication information, where the indication information indicates a resource occupied by the third signal; and determining the second signal from the first signal based on the indication information.

In the foregoing solution, the first apparatus receives the first signal, where the first signal includes the second signal and the third signal that causes the interference to the second signal, and learns of, based on the received indication information, the resource occupied by the third signal, so that the interference caused by the third signal can be accurately determined based on the resource occupied by the third signal. This helps accurately cancel the third signal from the first signal to obtain the second signal, to implement correct signal receiving and improve signal transmission quality.

In at least one embodiment, the determining the second signal from the first signal based on the indication information includes: determining, based on the indication information, an interference estimation value on the resource occupied by the third signal; and determining the second signal from the first signal based on the interference estimation value.

In the foregoing solution, the interference estimation value on the resource occupied by the third signal is first determined based on the resource that is occupied by the third signal and that is indicated by the indication information, and then the second signal is determined from the first signal based on the interference estimation value. This helps accurately determine the second signal.

A second aspect of at least one embodiment provides a communication method. The method is able to be performed by a second apparatus, and the second apparatus is a network device or a module (for example, a chip) used in the network device. The method includes: sending a second signal to a terminal device; and sending indication information to the terminal device, where the indication information indicates a resource occupied by a third signal that causes interference to the second signal.

In the foregoing solution, the second apparatus sends, to a first apparatus, the second signal and the indicated resource occupied by the third signal that causes the interference to the second signal. The first apparatus is able to learn of, based on the received indication information, the resource occupied by the third signal, so that the interference caused by the third signal can be accurately determined based on the resource occupied by the third signal. This helps accurately cancel the third signal to obtain the second signal, to implement correct signal receiving and improve signal transmission quality.

In at least one embodiment, the method further includes: sending the third signal to the terminal device.

A third aspect of at least one embodiment provides a communication method. The method includes: A second apparatus sends a second signal to a first apparatus. A third apparatus sends a third signal to the first apparatus, where the third signal causes interference to the second signal. A fourth apparatus sends indication information to the first apparatus, where the indication information indicates a resource occupied by the third signal.

In the foregoing solution, the first apparatus is able to learn of, based on the received indication information, the resource occupied by the third signal, so that the interference caused by the third signal can be accurately determined based on the resource occupied by the third signal. This helps accurately cancel the third signal to obtain the second signal, to implement correct signal receiving and improve signal transmission quality.

In at least one embodiment, the fourth apparatus is the same as the second apparatus, and the third apparatus is different from the second apparatus.

In at least one embodiment, the fourth apparatus is the same as the third apparatus, and the fourth apparatus is different from the second apparatus.

In at least one embodiment, the fourth apparatus, the second apparatus, and the third apparatus are the same.

In at least one embodiment, the fourth apparatus, the second apparatus, and the third apparatus are different from each other.

Based on any one of the first aspect to the third aspect of at least one embodiment:

In at least one embodiment, the indication information indicates a start location and a size of the resource occupied by the third signal.

In at least one embodiment, the indication information includes a precoding resource block group (precoding resource block group, PRG) start location, a PRG size, and a quantity of PRGs, the PRG start location indicates the start location of the resource occupied by the third signal, and the PRG size and the quantity of PRGs indicate the size of the resource occupied by the third signal.

In at least one embodiment, the indication information includes at least two sets of PRG information, and each set of PRG information includes a PRG start location, a PRG size, and a quantity of PRGs. The PRG start location indicates a start location of a part of the resource occupied by the third signal, and the PRG size and the quantity of PRGs indicate a size of the part of the resource.

In at least one embodiment, the indication information includes a reference point, an offset value, and a resource size, the reference point and the offset value indicate the start location of the resource occupied by the third signal, and the resource size indicates the size of the resource occupied by the third signal.

In at least one embodiment, the indication information is a bitmap, and first information in the bitmap indicates at least one resource element in the resource occupied by the third signal.

In the foregoing solution, the resource occupied by the third signal is accurately indicated by using the indication information. This helps the first apparatus accurately cancel the third signal to obtain the second signal, to implement correct signal receiving and improve signal transmission quality.

In at least one embodiment, the resource occupied by the third signal and a resource occupied by the second signal totally or partially overlap.

In at least one embodiment, the indication information further indicates at least one of the following information:
a port number of the third signal, where the port number indicates a source of the third signal;
a sequence of the third signal; and
scrambling code information of the third signal.

A fourth aspect of at least one embodiment provides a communication apparatus. The apparatus has a function of implementing any one of the implementation methods of the first aspect. The function is able to be implemented by hardware, or is able to be implemented by hardware by executing corresponding software. The hardware or the software includes one or more modules corresponding to the function.

A fifth aspect of at least one embodiment provides a communication apparatus. The apparatus has a function of implementing any one of the second aspect of at least one embodiment. The function is able to be implemented by hardware, or is able to be implemented by hardware by executing corresponding software. The hardware or the software includes one or more modules corresponding to the function.

A sixth aspect of at least one embodiment provides a communication apparatus, including a unit or a means (means) configured to perform steps of any one of the first aspect and the second aspect of at least one embodiment.

A seventh aspect of at least one embodiment provides a communication apparatus, including a processor and an interface circuit. The processor is configured to: communicate with another apparatus through the interface circuit, and perform any one of the first aspect and the second aspect of at least one embodiment. There are one or more processors.

An eighth aspect of at least one embodiment provides a communication apparatus, including a processor coupled to a memory. The processor is configured to invoke a program stored in the memory, to perform any one of the implementation methods of the first aspect and the second aspect. The memory is able to be located inside or outside the apparatus. In addition, the communication apparatus is able to have one or more processors.

A ninth aspect of at least one embodiment provides a communication apparatus, including a processor and a memory. The memory is configured to store computer instructions. When the apparatus runs, the processor executes the computer instructions stored in the memory, to enable the apparatus to perform any one of the first aspect and the second aspect of at least one embodiment.

A tenth aspect of at least one embodiment further provides a computer program product. The computer program product includes a computer program or instructions. When the computer program or the instructions are run by a communication apparatus, any one of the first aspect and the second aspect of at least one embodiment is performed.

An eleventh aspect of at least one embodiment further provides a computer-readable storage medium. The computer-readable storage medium stores instructions. When the instructions are run on a communication apparatus, any one of the first aspect and the second aspect of at least one embodiment is performed.

A twelfth aspect of at least one embodiment further provides a chip system, including a processor, configured to perform any one of the first aspect and the second aspect of at least one embodiment.

A thirteenth aspect of at least one embodiment further provides a communication system. The communication system includes a second apparatus, a third apparatus, and a fourth apparatus, and the communication system is configured to perform any one of the third aspect or the possible implementations of the third aspect of at least one embodiment.

### BRIEF DESCRIPTION OF DRAWINGS

FIG. 1(a) is a diagram of an architecture of a communication system according to at least one embodiment;

FIG. 1(b) is a diagram of a network device according to at least one embodiment;

FIG. 2 is a diagram of spatial multiplexing of a sensing signal and a data signal in an ISAC scenario according to at least one embodiment;

FIG. 3 is an example diagram of classification performed based on scenarios in an ISAC scenario according to at least one embodiment;

FIG. 4 is an example diagram of classification performed based on time-frequency resource overlap in an ISAC scenario according to at least one embodiment;

FIG. 5 is an example diagram of classification performed based on waveforms in an ISAC scenario according to at least one embodiment;

FIG. 6 is an example diagram of mismatch between PRGs of different data signals in a reflection scenario according to at least one embodiment;

FIG. 7 is an example diagram of classification performed based on scenarios in a reflection scenario according to at least one embodiment;

FIG. 8 is a diagram of three interference channels that are independent of each other and have different distributions according to at least one embodiment;

FIG. 9 is a schematic flowchart of a communication method according to at least one embodiment;

FIG. 10(a) is an example diagram of indicating a resource occupied by an interference signal according to at least one embodiment;

FIG. 10(b) is an example diagram of indicating a resource occupied by an interference signal according to at least one embodiment;

FIG. 10(c) is an example diagram of indicating a resource occupied by an interference signal according to at least one embodiment;

FIG. 11 is an example diagram of resource mapping between a sensing signal and a data signal according to at least one embodiment;

FIG. 12 is another example diagram of resource mapping between a sensing signal and a data signal according to at least one embodiment;

FIG. 13 is another example diagram of resource mapping between a sensing signal and a data signal according to at least one embodiment;

FIG. 14 is a diagram of a structure of a communication apparatus according to at least one embodiment; and

FIG. 15 is a diagram of a structure of a communication apparatus according to at least one embodiment.

### DESCRIPTION OF EMBODIMENTS

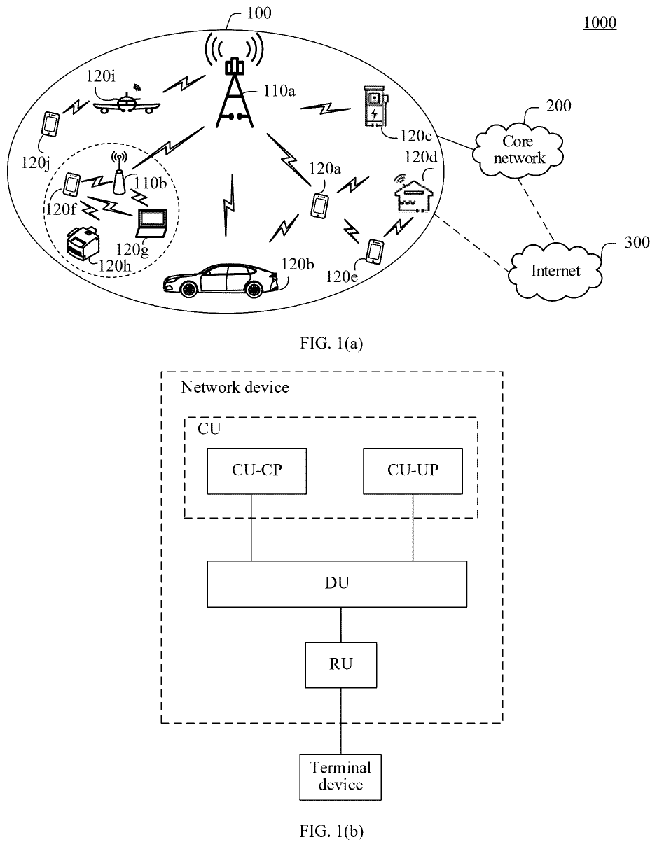

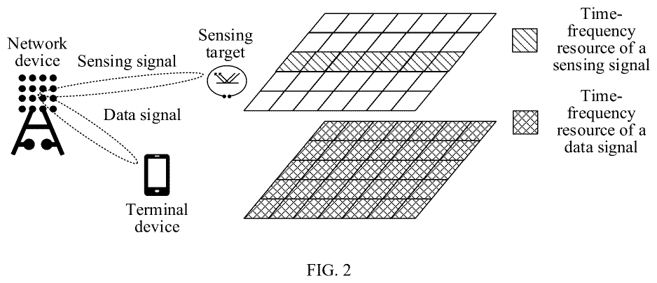

FIG. 1(a) is a diagram of an architecture of a communication system according to at least one embodiment. The communication system 1000 shown in FIG. 1(a) includes a radio access network 100 and a core network 200. In at least one embodiment, the communication system 1000 further includes an internet 300. In at least one embodiment, the radio access network 100 includes at least one network device (for example, 110a and 110b in FIG. 1(a)), and further includes at least one terminal device (for example, 120a to 120j in FIG. 1(a)). The terminal device is connected to the network device in a wireless manner, and the network device is connected to the core network in a wireless or wired manner. In at least one embodiment, a core network device and the network device are different physical devices that are independent of each other; functions of the core network device and logical functions of the network device are able to be integrated into a same physical device; or a part of functions of the core network device and a part of functions of the network device are able to be integrated into one physical device. In at least one embodiment, terminal devices are connected to each other in a wired or wireless manner, and network devices are connected to each other in a wired or wireless manner. In at least one embodiment, the communication system further includes another network device, for example, a wireless relay device and a wireless backhaul device, which are not shown in FIG. 1(a).

The network device is an access device for the terminal device to access the communication system in a wired or wireless manner. In at least one embodiment, the network device is a base station (base station), an evolved NodeB (evolved NodeB, eNodeB), a transmission reception point (transmission reception point, TRP), a next generation NodeB (next generation NodeB, gNB) in a 5th generation (5th generation, 5G) mobile communication system, a next generation base station in a 6th generation (6th generation, 6G) mobile communication system, a base station in a future mobile communication system, an access node in a wireless fidelity (wireless fidelity, Wi-Fi) system, or the like. In at least one embodiment, the network device is a module or a unit that completes a part of functions of a base station, for example, a central unit (central unit, CU), or a distributed unit (distributed unit, DU). In at least one embodiment, the CU herein completes functions of a radio resource control protocol layer and a packet data convergence protocol (packet data convergence protocol, PDCP) layer of the base station, and is able to further complete a function of a service data adaptation protocol (service data adaptation protocol, SDAP) layer. In at least one embodiment, the DU completes functions of a radio link control layer and a medium access control (medium access control, MAC) layer of the base station, and is able to further complete a part or all of functions of a physical layer. For detailed descriptions of the foregoing protocol layers, refer to technical specifications related to the 3rd generation partnership project (3rd generation partnership project, 3GPP). In at least one embodiment, the network device is a macro base station (for example, 110a in FIG. 1(a)), a micro base station or an indoor base station (for example, 110b in FIG. 1(a)), or a relay node, a donor node, or the like. A specific technology and a specific device form that are used by the network device are not limited in the at least one embodiment.

The terminal device is a device that has a wireless transceiver function, and is able to send a signal to the network device, or receive a signal from the network device. The terminal device includes but is not limited to a terminal apparatus, a terminal, user equipment (user equipment, UE), a mobile station, a mobile terminal, and the like. The terminal device is able to be widely used in various scenarios, for example, device-to-device (device-to-device, D2D), vehicle-to-everything (vehicle-to-everything, V2X) communication, machine-type communication (machine-type communication, MTC), an internet of things (internet of things, IoT), virtual reality, augmented reality, industrial control, self-driving, telemedicine, a smart grid, smart furniture, a smart office, smart wearable, smart transportation, and a smart city. In at least one embodiment, the terminal device is a mobile phone, a tablet computer, a computer with a wireless transceiver function, a wearable device, a vehicle, an airplane, a ship, a robot, a robot arm, a smart home device, or the like. A specific technology and a specific device form that are used by the terminal device are not limited in the at least one embodiment.

In at least one embodiment, the network device and the terminal device are at fixed locations or movable. In at least one embodiment, the network device and the terminal device are deployed on land, including an indoor or outdoor device, a handheld device, or a vehicle-mounted device; or are deployed on a water surface; or are deployed on a plane, a balloon, or an artificial satellite. Application scenarios of the network device and the terminal device are not limited in the at least one embodiment.

In at least one embodiment, roles of the network device and the terminal device are relative. For example, in at least one embodiment, a helicopter or an uncrewed aerial vehicle 120i in FIG. 1(a) is configured as a mobile network device. For the terminal device 120j that accesses the radio access network 100 through 120i, the terminal device 120i is a network device. However, for the network device 110a, 120i is a terminal device, that is, 110a and 120i communicate with each other by using a radio air interface protocol. Certainly, 110a and 120i are able to alternatively communicate with each other by using an interface protocol between network devices. In this case, compared with 110a, 120i is also a network device. Therefore, both the network device and the terminal device are able to be collectively referred to as communication apparatuses. In at least one embodiment, 110a and 110b in FIG. 1(a) are referred to as communication apparatuses having a function of the network device, and 120a to 120j in FIG. 1(a) are referred to as communication apparatuses having a function of the terminal device.

In at least one embodiment, communication between a network device and a terminal device, between network devices, or between terminal devices is performed by using a licensed spectrum, an unlicensed spectrum, or both a licensed spectrum and an unlicensed spectrum; or is performed by using a spectrum below 6 gigahertz (gigahertz, GHz), a spectrum above 6 GHz, or both a spectrum below 6 GHz and a spectrum above 6 GHz. A spectrum resource used for wireless communication is not limited in the at least one embodiment.

In at least one embodiment, a function of the network device is performed by a module (for example, a chip) in the network device, or is performed by a control subsystem including the function of the network device. In at least one embodiment, the control subsystem including the function of the network device is a control center in the foregoing application scenarios such as the smart grid, the industrial control, the smart transportation, and the smart city. In at least one embodiment, the function of the terminal device is performed by a module (for example, a chip or a modem) in the terminal device, or is performed by an apparatus including the function of the terminal device.

In at least one embodiment, the network device sends a downlink signal or downlink information to the terminal device, and the downlink information is carried on a downlink channel. The terminal device sends an uplink signal or uplink information to the network device, and the uplink information is carried on an uplink channel. To communicate with the network device, the terminal device needs to establish a wireless connection with a cell controlled by the network device. The cell that establishes the wireless connection with the terminal device is referred to as a serving cell of the terminal device.

FIG. 1(b) is a diagram of a network device according to at least one embodiment. As shown in FIG. 1(b), the network device includes one or more CUs, one or more DUs, and one or more radio units (radio units, RUs). For clarity, FIG. 1(b) shows only one CU, one DU, and one RU. The CU is configured to connect to a core network and the one or more DUs. In at least one embodiment, the CU has a part of functions of the core network. In at least one embodiment, the CU includes a CU-control plane (control plane, CP) and a CU-user plane (user plane, UP).

In at least one embodiment, the CU and the DU are configured based on functions, implemented by the CU and the DU, of protocol layers of a wireless network. For example, the CU is configured to implement functions of a packet data convergence protocol (packet data convergence protocol, PDCP) layer and an upper protocol layer (for example, a radio resource control (radio resource control, RRC) layer and/or a service data adaptation protocol (service data adaptation protocol, SDAP) layer), and the DU is configured to implement a function of a protocol layer (for example, a radio link control (radio link control, RLC) layer, a medium access control (medium access control, MAC) layer, and/or a physical (physical, PHY) layer) lower than the PDCP layer. For another example, the CU is configured to implement a function of a protocol layer (for example, an RRC layer and/or an SDAP layer) above a PDCP layer, and the DU is configured to implement functions of the PDCP layer and a lower protocol layer (for example, an RLC layer, a MAC layer, and/or a PHY layer).

The foregoing configuration of the CU and the DU is merely an example according to at least one embodiment. Alternatively, in at least one embodiment, functions of the CU and the DU are configured as required. For example, in at least one embodiment, the CU or the DU are configured to have functions of more protocol layers, or the CU or the DU are configured to have a part of processing functions of protocol layers. For example, a part of functions of the RLC layer and functions of a protocol layer above the RLC layer are set on the CU, and remaining functions of the RLC layer and functions of a protocol layer below the RLC layer are set on the DU. For another example, in at least one embodiment, division into functions of the CU or the DU are performed based on service types or other system requirements. For example, in at least one embodiment, division are performed based on a delay. Functions whose processing time needs to meet a requirement of a small delay are set on the DU, and functions whose processing time does not need to meet the requirement of the delay are set on the CU.

The DU and the RU are able to cooperate to jointly implement functions of the PHY layer. In at least one embodiment, one DU is connected to one or more RUs. In at least one embodiment, functions of the DU and the RU are configured into a plurality of manners based on a design. For example, the DU is configured to implement a baseband function, and the RU is configured to implement an intermediate radio frequency function. For another example, the DU is configured to implement higher-layer functions of the PHY layer, and the RU is configured to implement lower-layer functions of the PHY layer or implement the lower-layer functions and a radio frequency function. In at least one embodiment, the higher-layer functions of the physical layer include a part of functions of the physical layer, and the part of functions are closer to the MAC layer. In at least one embodiment, the lower-layer functions of the physical layer include the other functions of the physical layer, and the other functions are closer to an intermediate radio frequency side.

In at least one embodiment, the following describes signal interference in two different scenarios. The at least one embodiment does not constitute a limitation on an application scenario of the at least one embodiment.

### Scenario I: Integrated Sensing and Communications (Integrated Sensing and Communications, ISAC) Scenario

FIG. 2 is a diagram of spatial multiplexing of a sensing signal and a data signal in an ISAC scenario. Each row in the figure represents one resource block (resource block, RB), and each RB includes a plurality of REs. A network device sends a data signal (for example, a physical downlink shared channel (physical downlink shared channel, PDSCH) signal) to a terminal device, and further sends a sensing signal, to detect a location of a sensing target. A part of resource elements (resource elements, REs) in a time-frequency resource on which the sensing signal is located and a time-frequency resource on which the data signal is located overlap. In other words, spatial multiplexing is performed on the part of REs, so that the part of REs can carry both the data signal and the sensing signal. For receiving of the data signal by the terminal device, the sensing signal is an interference signal, that is, the sensing signal causes interference to receiving of the data signal by the terminal device.

The time-frequency resource on which the data signal is located is able to be divided based on precoding resource block groups (precoding resource block groups, PRGs). For one PRG shown in FIG. 2, the PRG includes one or more RBs. The sensing signal causes interference only to data signals on a part of REs of the PRG, and does not cause interference to data signals on all REs of the PRG. In other words, the PRG of the data signal does not completely match the time-frequency resource on which the sensing signal that causes interference to the data signal is located.

The PRG is used as an example for description in at least one embodiment, but is not limited thereto. The solution in the at least one embodiment is able to be applied to a case in which a time-frequency resource is divided in any grouping manner, for example, a case in which the time-frequency resource is divided based on interference resource block groups (interference resource block groups, IRGs) or resource block groups (resource block groups, RBGs).

In at least one embodiment, in a multiple-input and multiple-output (multiple-input and multiple-output, MIMO) transmission scenario, the data signal is also referred to as a MIMO transmission signal.

For the ISAC scenario, the following provides classification examples in different division manners.

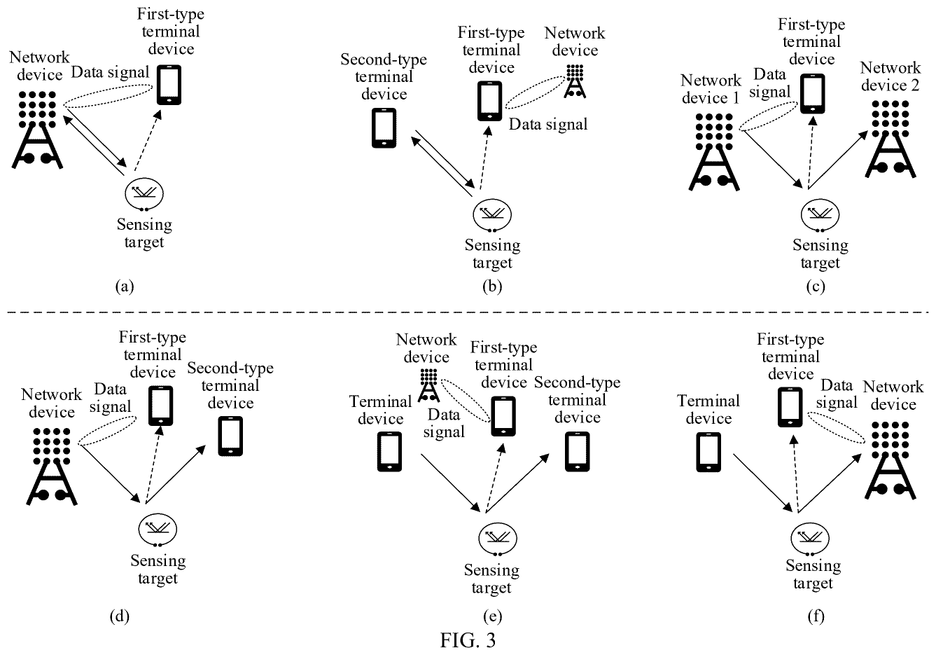

FIG. 3 is an example diagram of classification performed based on scenarios in the ISAC scenario according to at least one embodiment. In the ISAC scenario according to at least one embodiment, terminal devices is classified into a first-type terminal device and a second-type terminal device. The first-type terminal device is a terminal device that receives a data signal, and the second-type terminal device is a terminal device that receives a sensing signal. In at least one embodiment, the sensing signal received by the second-type terminal device is reflected by a sensing target to the second-type terminal device after a network device, another terminal device, or the second-type terminal device sends the sensing signal to the sensing target. In at least one embodiment, the second-type terminal device further receives the data signal.

In (a) in FIG. 3, a network device sends a data signal to a first-type terminal device, and the network device further sends a sensing signal to a sensing target and receives the sensing signal reflected by the sensing target. The first-type terminal device receives the data signal, and is able to further receive the sensing signal. In at least one embodiment, the sensing signal received by the first-type terminal device is the sensing signal sent by the network device, or is the sensing signal reflected by the sensing target. The sensing signal causes interference to receiving of the data signal by the first-type terminal device. Therefore, the sensing signal is an interference signal that exists when the first-type terminal device receives the data signal.

In (b) in FIG. 3, a network device sends a data signal to a first-type terminal device, and a second-type terminal device sends a sensing signal to a sensing target and receives the sensing signal reflected by the sensing target. The first-type terminal device receives the data signal, and is able to further receive the sensing signal. In at least some embodiment, the sensing signal received by the first-type terminal device is the sensing signal of the second-type terminal device, or is the sensing signal reflected by the sensing target. The sensing signal causes interference to receiving of the data signal by the first-type terminal device. Therefore, the sensing signal is an interference signal that exists when the first-type terminal device receives the data signal. In at least one embodiment, the second-type terminal device sends and receives the sensing signal, and is able to further receive the data signal sent by the network device to the first-type terminal device. The data signal causes interference to sending or receiving of the sensing signal by the second-type terminal device. Therefore, the data signal is an interference signal that exists when the second-type terminal device sends or receives the sensing signal.

In (c) in FIG. 3, a network device 1 sends a data signal to a first-type terminal device, and the network device 1 further sends a sensing signal to a sensing target. A network device 2 receives the sensing signal reflected by the sensing target. The first-type terminal device receives the data signal, and is able to further receive the sensing signal. In at least one embodiment, the sensing signal received by the first-type terminal device is the sensing signal sent by the network device 1, or is the sensing signal reflected by the sensing target. The sensing signal causes interference to receiving of the data signal by the first-type terminal device. Therefore, the sensing signal is an interference signal that exists when the first-type terminal device receives the data signal.

In (d) in FIG. 3, a network device sends a data signal to a first-type terminal device, and the network device further sends a sensing signal to a sensing target. A second-type terminal device receives the sensing signal reflected by the sensing target. The first-type terminal device receives the data signal, and is able to further receive the sensing signal. In at least one embodiment, the sensing signal received by the first-type terminal device is the sensing signal sent by the network device, or is the sensing signal reflected by the sensing target. The sensing signal causes interference to receiving of the data signal by the first-type terminal device. Therefore, the sensing signal is an interference signal that exists when the first-type terminal device receives the data signal. The second-type terminal device receives the sensing signal, and is able to further receive the data signal sent by the network device to the first-type terminal device. The data signal causes interference to receiving of the sensing signal by the second-type terminal device. Therefore, the data signal is an interference signal that exists when the second-type terminal device receives the sensing signal.

In (e) in FIG. 3, a network device sends a data signal to a first-type terminal device. A terminal device sends a sensing signal to a sensing target. A second-type terminal device receives the sensing signal reflected by the sensing target. The first-type terminal device receives the data signal, and is able to further receive the sensing signal. In at least one embodiment, the sensing signal received by the first-type terminal device is the sensing signal sent by the terminal device, or is the sensing signal reflected by the sensing target. The sensing signal causes interference to receiving of the data signal by the first-type terminal device. Therefore, the sensing signal is an interference signal that exists when the first-type terminal device receives the data signal. The second-type terminal device receives the sensing signal, and is able to further receive the data signal sent by the network device to the first-type terminal device. The data signal causes interference to receiving of the sensing signal by the second-type terminal device. Therefore, the data signal is an interference signal that exists when the second-type terminal device receives the sensing signal.

In (f) in FIG. 3, a network device sends a data signal to a first-type terminal device. A terminal device sends a sensing signal to a sensing target. The network device receives the sensing signal reflected by the sensing target. The first-type terminal device receives the data signal, and is able to further receive the sensing signal. In at least one embodiment, the sensing signal received by the first-type terminal device is the sensing signal sent by the terminal device, or is the sensing signal reflected by the sensing target. The sensing signal causes interference to receiving of the data signal by the first-type terminal device. Therefore, the sensing signal is an interference signal that exists when the first-type terminal device receives the data signal.

For the second-type terminal device, if the second-type terminal device further receives, when sending or receiving a sensing signal, a data signal sent by the network device or another terminal device to the second-type terminal device, the data signal and the sensing signal are interference signals of each other.

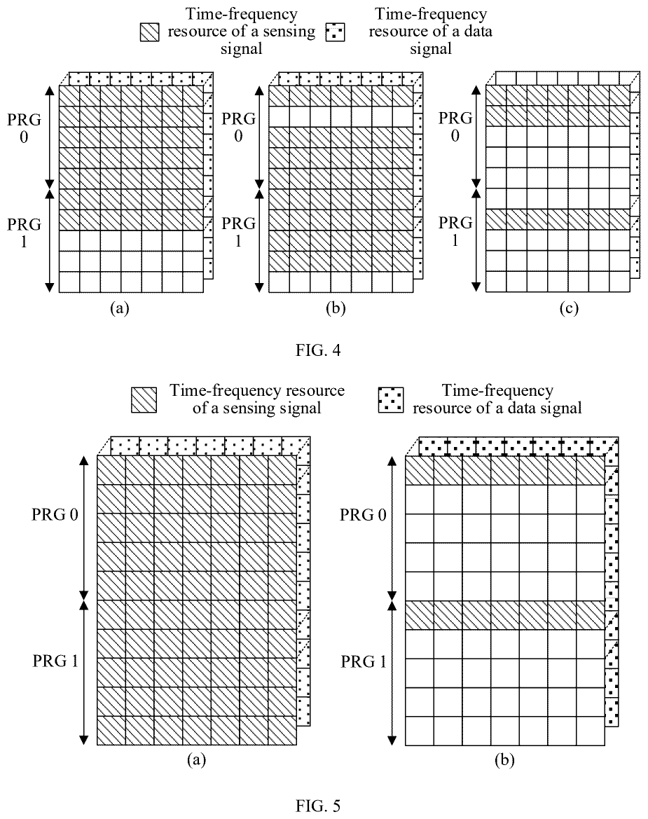

FIG. 4 is an example diagram of classification performed based on time-frequency resource overlap (overlap) in the ISAC scenario according to at least one embodiment. Each row in the figure represents one RB. In (a) in FIG. 4, a time-frequency resource of a sensing signal and a PRG of a data signal partially overlap. The partial overlapping herein means that an overlapping proportion is less than or equal to a first threshold and is greater than 0. In (b) in FIG. 4, a time-frequency resource of a sensing signal and a PRG of a data signal completely overlap. The complete overlapping herein means that an overlapping proportion is greater than a threshold. In other words, when the overlapping proportion is greater than the threshold, the time-frequency resource of the sensing signal and the PRG of the data signal completely overlap. In (c) in FIG. 4, a time-frequency resource of a sensing signal and a PRG of a data signal do not overlap, that is, an overlapping proportion is equal to 0.

FIG. 5 is an example diagram of classification performed based on waveforms in the ISAC scenario according to at least one embodiment. Each row in the figure represents one RB. In (a) in FIG. 5, a sensing signal and a data signal belong to a same waveform, and a time-frequency resource of the sensing signal and a PRG of the data signal completely overlap. The complete overlapping herein means that an overlapping proportion is greater than a threshold. In other words, when the overlapping proportion is greater than the threshold, the time-frequency resource of the sensing signal and the PRG of the data signal completely overlap. In (b) in FIG. 5, a sensing signal and a data signal belong to different waveforms, and a time-frequency resource of the sensing signal and a PRG of the data signal partially overlap.

### Scenario II: Reflection Scenario

The reflection scenario includes a reconfigurable intelligent surface (reconfigurable intelligent surface, RIS) scenario and an intelligent reflecting surface (intelligent reflecting surface, IRS) scenario.

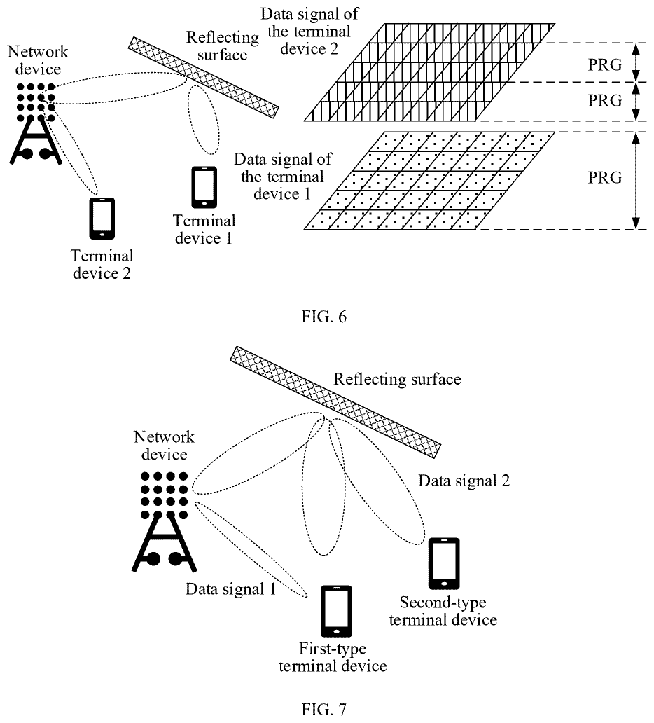

FIG. 6 is an example diagram of mismatch between PRGs of different data signals in the reflection scenario according to at least one embodiment. Each row in the figure represents one RB. A terminal device 1 receives a reflected data signal, and a terminal device 2 receives a data signal that is not reflected. A size of a PRG of the data signal received by the terminal device 1 is different from a size of a PRG of the data signal received by the terminal device 2. Therefore, the PRG of the data signal received by the terminal device 1 does not match the PRG of the data signal received by the terminal device 2. In the example in FIG. 6, the PRG of the data signal received by the terminal device 1 occupies five RBs, and the PRG of the data signal received by the terminal device 2 occupies two RBs. Therefore, the PRG of the data signal received by the terminal device 1 is larger than the PRG of the data signal received by the terminal device 2. In other words, a granularity of the PRG corresponding to the terminal device 1 is different from a granularity of the PRG corresponding to the terminal device 2.

FIG. 7 is an example diagram of classification performed based on scenarios in the reflection scenario according to at least one embodiment. A first-type terminal device normally receives a data signal 1, and a second-type terminal device receives a reflected data signal 2. When receiving the data signal 1, the first-type terminal device is able to further receive the data signal 2. The data signal 2 causes interference to receiving of the data signal 1 by the first-type terminal device. Therefore, the data signal 2 is an interference signal that exists when the first-type terminal device receives the data signal 1. When receiving the data signal 2, the second-type terminal device is able to further receive the data signal 1. The data signal 1 causes interference to receiving of the data signal 2 by the second-type terminal device. Therefore, the data signal 1 is an interference signal that exists when the second-type terminal device receives the data signal 2.

In the current technology, the terminal device performs DMRS resource bundling (bundling) based on a PRG by default based on protocol predefinition, to perform channel and interference estimation. In other words, the terminal device considers by default that the interference signal covers all REs of the PRG. In addition, one terminal device has only one PRG value in one time unit, and each PRG value is two RBs, four RBs, or the like.

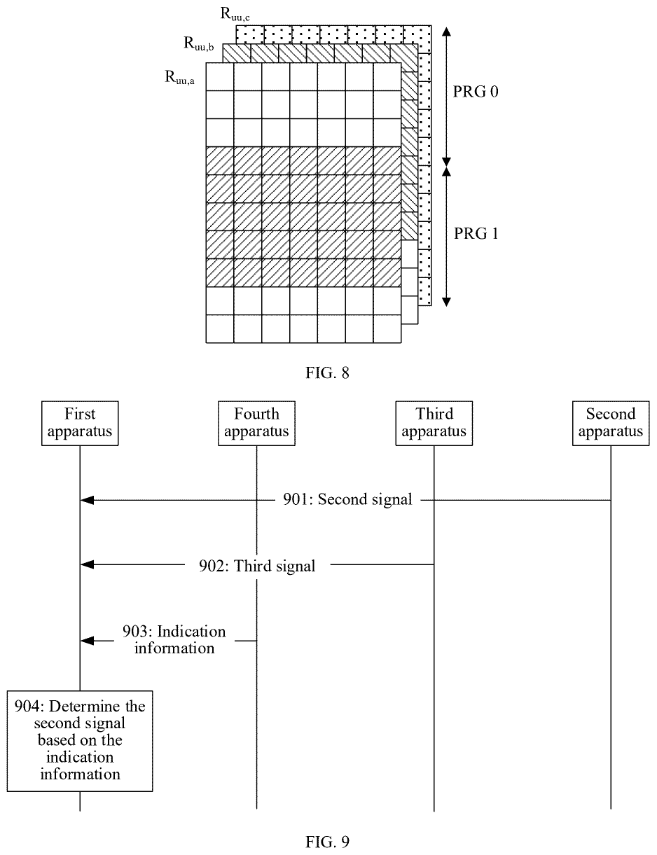

The following describes a current interference estimation method with reference to an example in FIG. 8. FIG. 8 is a diagram of three interference channels that are independent of each other and have different distributions according to at least one embodiment. Each row in the figure represents one RB. For a specific RE, a model of a received signal on the RE is:

ŷ=W·r

ŷ is a transmission signal on which equalization is performed, that is, a transmission signal on which interference cancellation is performed, and a dimension is a complex number vector of nlayer*1, where nlayer is a quantity of streams at a receive end. In at least one embodiment, the transmission signal is a data signal, a sensing signal, or the like.

r is a received signal on which equalization is not performed, that is, the received signal is a superimposed signal of a transmission signal and at least one interference signal, and a dimension is nrx*1, where nrx is a quantity of receiver antennas. In the example in FIG. 8, three interference signals, namely, interference signals a, b, and c, exist.

W is an equalization coefficient matrix, and a dimension is nlayer*nrx. The expression is as follows:

$$W = \text{?} \cdot {( \text{?} \cdot \text{?} + {R}_{uu} + {σ}^{2} I )}^{- 1}$$

[symbol] is an estimation value of an equivalent channel matrix of a terminal device on an RE, [symbol] ^{H} is a conjugate transposed matrix of [symbol] , and a dimension is nrx*nlayer. σ² represents an estimation value of a noise floor power. I is a unit matrix, and a dimension is nrx*nrx. Rᵤᵤ is an interference covariance matrix.

Using the foregoing three independent interference channels as an example, the expression of Rᵤᵤ is as follows:

$${R}_{uu} = {R}_{uu , a} + {R}_{uu , b} + {R}_{uu , c}$$

R_{uu,a}, R_{uu,b}, and R_{uu,c} respectively represent covariance matrices of the three mutually independent interference channels. When distributions of the three independent interference channels in time domain or frequency domain are not completely the same, differentiated processing needs to be performed on Rᵤᵤ in each PRG.

Refer to FIG. 8. For the interference signal a, the interference signal a exists on a part of REs of a PRG 0, and the interference signal a does not exist on the other REs. Similarly, the interference signal a exists on a part of REs of a PRG 1, and the interference signal a does not exist on the other REs. According to a current method, the terminal device considers by default that the interference signal a exists on all PRGs. Therefore, the terminal device calculates, in a manner of averaging interference signals a on all REs in the PRG 0, R_{uu,a} corresponding to each RE in the PRG 0, and calculates, in a manner of averaging interference signals a on all REs in the PRG 1, R_{uu,a} corresponding to each RE in the PRG 1.

Similarly, the terminal device calculates, in a manner of averaging interference signals b on all the REs in the PRG 0, R_{uu,b} corresponding to each RE in the PRG 0, and calculates, in a manner of averaging interference signals b on all the REs in the PRG 1, R_{uu,b} corresponding to each RE in the PRG 1. Therefore, each RE corresponds to the same covariance matrix R_{uu,b}.

Similarly, the terminal device calculates, in a manner of averaging interference signals c on all the REs in the PRG 0, R_{uu,c} corresponding to each RE in the PRG 0, and calculates, in a manner of averaging interference signals c on all the REs in the PRG 1, R_{uu,c} corresponding to each RE in the PRG 1. Therefore, each RE corresponds to the same covariance matrix R_{uu,c}.

In the current technology, the terminal device does not know a time-frequency resource location actually occupied by the interference signal. Therefore, the terminal device considers by default that the interference signal exists on all the REs in the PRG, and then calculates Rᵤᵤ in a manner of averaging interference signals on all REs in one PRG. This manner is not applicable to a scenario in which a PRG of a transmission signal does not completely match a time-frequency resource of an interference signal. Specifically, in the scenario in which the PRG of the transmission signal does not completely match the time-frequency resource of the interference signal, for example, the interference signal a and the interference signal b, if Rᵤᵤ is calculated in a manner of averaging interference signals on all REs in the PRG, interference calculation on each RE may be inaccurate, affecting equalization quality and causing deterioration of system spectral efficiency. This is because there may be no interference signal on an RE actually, and if Rᵤᵤ is calculated in the manner of averaging the interference signals on all the REs in the PRG, it is considered that an interference signal exists on these REs. Therefore, equalization quality is reduced.

FIG. 9 is a schematic flowchart of a communication method according to at least one embodiment. The method includes the following steps.

Step 901: A second apparatus sends a second signal to a first apparatus.

Step 902: A third apparatus sends a third signal to the first apparatus, where the third signal causes interference to the second signal.

The third signal is also referred to as an interference signal of the second signal.

A resource occupied by the third signal and a resource occupied by the second signal totally or partially overlap. The complete overlapping herein means that an overlapping proportion is greater than a threshold. In other words, when the overlapping proportion is greater than the threshold, the resource occupied by the third signal and the resource occupied by the second signal completely overlap.

In at least one embodiment, if the second apparatus and the third apparatus are a same apparatus, the second signal and the third signal is able to be sent in a spatial multiplexing manner. For example, if a first signal is obtained through spatial multiplexing performed on the second

T signal and the third signal, the first apparatus receives the first signal, the first signal includes both the second signal and the third signal, and the third signal causes the interference to the second signal. Therefore, the first apparatus needs to cancel the third signal from the first signal to obtain the second signal.

In at least one embodiment, the second signal and the third signal occupy different time-frequency resources, but signal superimposition occurs when the second signal and the third signal arrive at the first apparatus, and a superimposed signal is referred to as a first signal. In this case, the first apparatus receives the first signal, the first signal includes both the second signal and the third signal, and the third signal causes the interference to the second signal. Therefore, the first apparatus needs to cancel the third signal from the first signal to obtain the second signal.

Step 903: A fourth apparatus sends indication information to the first apparatus, where the indication information indicates the resource occupied by the third signal.

The resource that is occupied by the third signal and that is indicated by the indication information includes a time domain resource and/or a frequency domain resource.

In at least one embodiment, the indication information further indicates at least one of the following information:
(1) a port number of the third signal, where the port number indicates a source of the third signal;
(2) a sequence of the third signal; and
(3) scrambling code information of the third signal.

In at least one embodiment, when calculating the interference caused by the third information to the second signal, the first apparatus is one or more of the port number, the sequence, or the scrambling code information of the third signal.

Step 904: The first apparatus determines the second signal based on the indication information.

In at least one embodiment, the first apparatus is a terminal device or a module (for example, a chip) used in the terminal device.

In at least one embodiment, the second apparatus is a network device or a module (for example, a chip) used in the network device, or a terminal device or a module (for example, a chip) used in the terminal device.

In at least one embodiment, the third apparatus is a network device or a module (for example, a chip) used in the network device, or a terminal device or a module (for example, a chip) used in the terminal device.

In at least one embodiment, the fourth apparatus is a network device or a module (for example, a chip) used in the network device, or a terminal device or a module (for example, a chip) used in the terminal device.

In at least one embodiment, the second apparatus, the third apparatus, and the fourth apparatus are able to be same apparatuses (that is, a same apparatus), or are able to be different apparatuses (that is, not a same apparatus), or any two of the apparatuses are the same and different from the other apparatus (that is, any two of the apparatuses are a same apparatus and the other apparatus is not the same apparatus). This is not limited to the at least one embodiment.

In at least one embodiment, there is a plurality of third signals that cause interference, and the third signals are able to come from a plurality of third apparatuses.

The following describes specific implementations of the first apparatus, the second apparatus, the third apparatus, and the fourth apparatus with reference to the scenario examples in FIG. 3 and FIG. 7.

For (a) in FIG. 3, the second apparatus, the third apparatus, and the fourth apparatus are the same (that is, a same apparatus) and are all network devices, and the first apparatus is a first-type terminal device. The second signal is a data signal, and the third signal is a sensing signal.

For (b) in FIG. 3, in at least one embodiment, the second apparatus and the fourth apparatus are the same (that is, a same apparatus) and are both network devices, the third apparatus is a second-type terminal device, and the first apparatus is a first-type terminal device. The second signal is a data signal, and the third signal is a sensing signal. In at least one embodiment, the second apparatus is a network device, the third apparatus and the fourth apparatus are the same (that is, a same apparatus) and are both second-type terminal devices, and the first apparatus is a first-type terminal device. The second signal is a data signal, and the third signal is a sensing signal.

For (c) in FIG. 3, the second apparatus, the third apparatus, and the fourth apparatus are the same (that is, a same apparatus) and are all network devices 1, and the first apparatus is a first-type terminal device. The second signal is a data signal, and the third signal is a sensing signal.

For (d) or (e) in FIG. 3, in at least one embodiment, the second apparatus, the third apparatus, and the fourth apparatus are the same (that is, a same apparatus) and are all network devices, and the first apparatus is a first-type terminal device. The second signal is a data signal, and the third signal is a sensing signal. In at least one embodiment, the second apparatus, the third apparatus, and the fourth apparatus are the same (that is, a same apparatus) and are all network devices, and the first apparatus is a second-type terminal device. The second signal is a sensing signal, and the third signal is a data signal.

For (f) in FIG. 3, the second apparatus and the fourth apparatus are the same (that is, a same apparatus) and are both network devices, the third apparatus is a terminal device that sends a sensing signal, and the first apparatus is a first-type terminal device. The second signal is a data signal, and the third signal is a sensing signal.

For FIG. 7, in at least one embodiment, the second apparatus, the third apparatus, and the fourth apparatus are the same (that is, a same apparatus) and are all network devices, and the first apparatus is a first-type terminal device. The second signal is a data signal 1, and the third signal is a data signal 2. In at least one embodiment, the second apparatus, the third apparatus, and the fourth apparatus are the same (that is, a same apparatus) and are all network devices, and the first apparatus is a second-type terminal device. The second signal is a data signal 2, and the third signal is a data signal 1.

In the foregoing solutions, the first apparatus receives the first signal, where the first signal includes the second signal and the third signal that causes the interference to the second signal. The first apparatus learns of, based on the received indication information, the resource occupied by the third signal, so that the interference caused by the third signal can be accurately determined based on the resource occupied by the third signal. This helps accurately cancel the third signal from the first signal to obtain the second signal, to implement correct signal receiving and improve signal transmission quality.

According to the foregoing descriptions, in the conventional technology, the terminal device cannot accurately learn of a location of the resource occupied by the third signal that causes the interference to the second signal, and the terminal device considers by default that there is an interference signal on all REs of a PRG. Therefore, interference signal cancellation may not be accurate.

In at least one embodiment, the first apparatus determines, based on the indication information, an interference estimation value on the resource occupied by the third signal, and then determines the second signal from the first signal based on the interference estimation value.

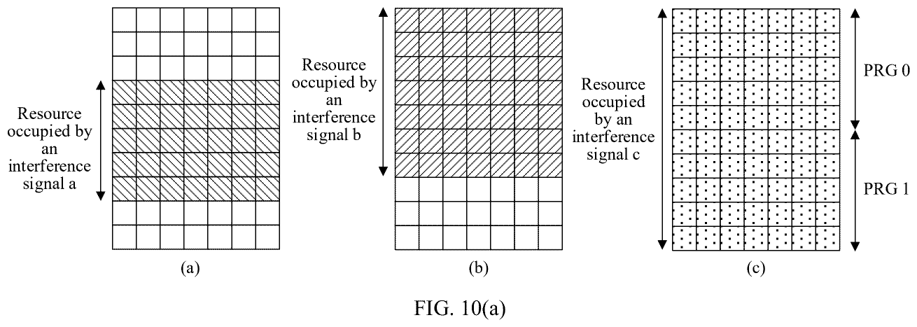

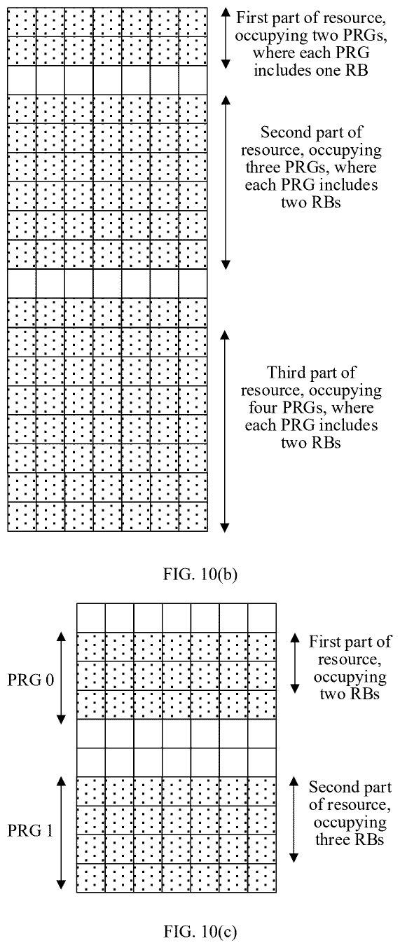

For the example in FIG. 8, if an interference estimation value on each RE is calculated according to at least one embodiment, resources occupied by the interference signal a, the interference signal b, and the interference signal c are respectively indicated by using three different pieces of indication information. FIG. 10(a) is an example diagram of indicating a resource occupied by an interference signal according to at least one embodiment. Each row in the figure represents one RB. For example, indication information 1 indicates a resource occupied by an interference signal a, indication information 2 indicates a resource occupied by an interference signal b, and indication information 3 indicates a resource occupied by an interference signal c. The interference signal a, the interference signal b, and the interference signal c herein are all specific examples of the third signal.

For the interference signal a, the interference signal a exists on a part of REs of a PRG 0, and the interference signal a does not exist on the other REs. Similarly, the interference signal a exists on a part of REs of a PRG 1, and the interference signal a does not exist on the other REs. According to at least one embodiment, the first apparatus is able to calculate, in a manner of averaging interference signals a on the resource indicated by the indication information 1, R_{uu,a} corresponding to each RE on the resource indicated by the indication information 1. For a resource that is not indicated, there is no interference signal a on the resource.

Similarly, the first apparatus is able to calculate, in a manner of averaging interference signals b on the resource indicated by the indication information 2, R_{uu,b} corresponding to each RE on the resource indicated by the indication information 2. For a resource that is not indicated, there is no interference signal b on the resource.

Similarly, the first apparatus is able to calculate, in a manner of averaging interference signal c on the resource indicated by the indication information 3, R_{uu,c} corresponding to each RE on the resource indicated by the indication information 3. For a resource that is not indicated, there is no interference signal c on the resource.

The following describes a plurality of implementation methods of the indication information in in at least some embodiments.

Method I: The indication information indicates a start location and a size of the resource occupied by the third signal.

For example, the indication information includes a PRG start location, a PRG size, and a quantity of PRGs. The PRG start location indicates the start location of the resource occupied by the third signal, the PRG size indicates a quantity of RBs occupied by one PRG, the quantity of PRGs indicates a quantity of PRGs occupied by the third signal, and the PRG size and the quantity of PRGs jointly indicate the size of the resource occupied by the third signal. In at least one embodiment, the quantity of PRGs is a positive integer, or is a decimal or a fraction. This manner is applicable to a scenario in which the third signal occupies a part or all of resources of one or more PRGs. For example, in at least one embodiment, for the interference signal c, the resource occupied by the interference signal c is indicated in this manner.

For another example, the indication information includes at least two sets of PRG information, and each set of PRG information includes a PRG start location, a PRG size, and a quantity of PRGs. The PRG start location indicates a start location of a part of the resource occupied by the third signal, the PRG size indicates a quantity of RBs occupied by one PRG, the quantity of PRGs indicates a quantity of PRGs occupied by the part of the resource, and the PRG size and the quantity of PRGs jointly indicate a size of the part of the resource. One PRG includes one or more consecutive RBs. In at least one embodiment, the quantity of PRGs is a positive integer, or is a decimal, a fraction, or the like. FIG. 10(b) is an example diagram of indicating a resource occupied by an interference signal according to at least one embodiment. Each row in the figure represents one RB. In this example, the resource occupied by the third signal includes three parts of resources. A first part of resource occupies two PRGs and each PRG includes one RB, a second part of resource occupies three PRGs and each PRG includes two RBs, and a third part of resource occupies four PRGs and each PRG includes two RBs. Therefore, the resource occupied by the third signal is able to be indicated by using three sets of PRG information. For example, a PRG start location in a first set of PRG information indicates a start location of the first part of resource, a PRG size in the first set of PRG information is one RB, and a quantity of PRGs in the first set of PRG information is two PRGs. Therefore, a size of the first part of resource is two RBs. A PRG start location in a second set of PRG information indicates a start location of the second part of resource, a PRG size in the second set of PRG information is two RBs, and a quantity of PRGs in the second set of PRG information is three PRGs. Therefore, a size of the second part of resource is six RBs. A PRG start location in a third set of PRG information indicates a start location of the third part of resource, a PRG size in the third set of PRG information is two RBs, and a quantity of PRGs in the third set of PRG information is four PRGs. Therefore, a size of the third part of resource is eight RBs. FIG. 10(c) is an example diagram of indicating a resource occupied by an interference signal according to at least one embodiment. Each row in the figure represents one RB. In this example, the resource occupied by the third signal includes two parts of resources. A first part of resource occupies two RBs in a PRG 0, where the PRG 0 includes three RBs; and a second part of resource occupies three RBs in a PRG 1, where the PRG 1 includes four RBs. Therefore, the resource occupied by the third signal is able to be indicated by using two sets of PRG information. For example, a PRG start location in a first set of PRG information indicates a start location of the first part of resource, a PRG size in the first set of PRG information indicates a quantity of RBs occupied by one PRG, and a quantity of PRGs in the first set of PRG information indicates a quantity of PRGs occupied by the first part of resource. Specifically, the PRG size in the first set of PRG information is three RBs, and the quantity of PRGs in the first set of PRG information is 2/3. A PRG start location in a second set of PRG information indicates a start location of the second part of resource, a PRG size in the second set of PRG information indicates a quantity of RBs occupied by one PRG, and a quantity of PRGs in the second set of PRG information indicates a quantity of PRGs occupied by the first part of resource. Specifically, the PRG size in the second set of PRG information is four RBs, and the quantity of PRGs in the first set of PRG information is 3/4.

For another example, the indication information includes a reference point, an offset value, and a resource size, the reference point and the offset value indicate the start location of the resource occupied by the third signal, and the resource size indicates the size of the resource occupied by the third signal. This manner is applicable to a scenario in which the third signal occupies a consecutive resource. For example, in at least one embodiment, for the interference signals a, b, and c, the resource occupied by the interference signal a, b, or c is indicated in this manner.

Method II: The indication information is a bitmap, and first information in the bitmap indicates at least one resource element in the resource occupied by the third signal.

Each bit in the bitmap corresponds to K REs, K is a positive integer, and a value of each bit is first information or second information. The first information is 1, and the second information is 0, or the first information is 0, and the second information is 1.

For example, if the bitmap is 1111100000101100101, K=1, and the first information is 1, interference signals exist on REs corresponding to all bits whose values are 1 in the bitmap.

The following describes a multiplexing manner of a time-frequency resource that exists between a data signal and a sensing signal according to at least one embodiment.

Scenario 1: The first apparatus in the embodiment in FIG. 9 is the first-type terminal device in the scenario in FIG. 3. The first-type terminal device receives a data signal, a sensing signal is an interference signal of the data signal, and the sensing signal is mapped by multiplexing a resource of a DMRS port.

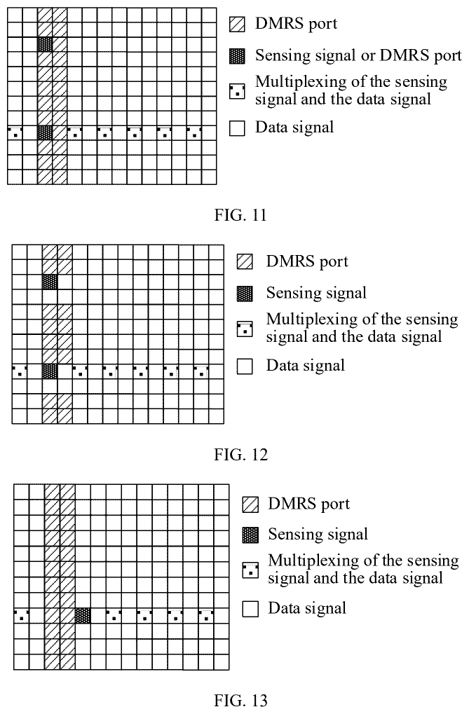

FIG. 11 is an example diagram of resource mapping between a sensing signal and a data signal according to at least one embodiment. Each box in the figure represents one RE. In this example, a part of the sensing signal uses an existing DMRS port, that is, signals carried on a part of REs represent both a DMRS signal and a sensing signal. The other part of the sensing signal and the data signal are multiplexed on a same RE, that is, the RE carries both the data signal and the sensing signal.

FIG. 12 is another example diagram of resource mapping between a sensing signal and a data signal according to at least one embodiment. Each box in the figure represents one RE. In this example, a part of the sensing signal uses an idle DMRS port, that is, a part of REs independently carry the sensing signal. The other part of the sensing signal and the data signal are multiplexed on a same RE, that is, the RE carries both the data signal and the sensing signal.

Scenario 2: The first apparatus in the embodiment in FIG. 9 is the first-type terminal device in the scenario in FIG. 3 according to at least one embodiment. The first-type terminal device receives a data signal, a sensing signal is an interference signal of the data signal, and the sensing signal is mapped by using an independent resource.

FIG. 13 is another example diagram of resource mapping between a sensing signal and a data signal according to at least one embodiment. Each box in the figure represents one RE. In this example, a part of the sensing signal independently occupies a time-frequency resource on which a non-DMRS port is located, that is, the sensing signal is mapped by using an independent resource. The other part of the sensing signal and the data signal are multiplexed on a same RE, that is, the RE carries both the data signal and the sensing signal.

Scenario 3: The first apparatus in the embodiment in FIG. 9 is the second-type terminal device in the scenario in FIG. 3 according to at least one embodiment. The second-type terminal device receives only a sensing signal, and does not perform data transmission. A data signal received by the second-type terminal device is an interference signal of the sensing signal. In at least one embodiment, the data signal is sent by a network device to a first-type terminal device but is able to be received by the second-type terminal device, and the sensing signal is mapped by multiplexing a resource of a DMRS port.

For an example of resource mapping between the sensing signal and the data signal in this scenario, refer to FIG. 11 and FIG. 12.

Scenario 4: The first apparatus in the embodiment in FIG. 9 is the second-type terminal device in the scenario in FIG. 3 according to at least one embodiment. The second-type terminal device receives a sensing signal, and also performs data transmission. A data signal 1 and a data signal 2 received by the second-type terminal device are interference signals of the sensing signal. The data signal 1 is sent by a network device to a first-type terminal device but is able to be received by the second-type terminal device, the data signal 2 is sent by the network device to the second-type terminal device, and the sensing signal is mapped by multiplexing a resource of a DMRS port.

For an example of resource mapping between the sensing signal and the data signal in this scenario, refer to FIG. 11 and FIG. 12.

Scenario 5: The first apparatus in the embodiment in FIG. 9 is the first-type terminal device in the scenario in FIG. 7 according to at least one embodiment. The first-type terminal device receives a data signal 1 and a data signal 2. The data signal 1 is sent by a network device to the first-type terminal device, the data signal 2 is sent by the network device to a second-type terminal device but is able to be received by the first-type terminal device, the data signal 2 is an interference signal of the data signal 1, the data signal 1 is transmitted by using a narrow-band beam, and the data signal 2 is transmitted by using a wide-band beam.

For an example of resource mapping between the data signal 1 and the data signal 2 in this scenario, refer to FIG. 6.

Scenario 6: The first apparatus in the embodiment in FIG. 9 is the second-type terminal device in the scenario in FIG. 7 according to at least one embodiment. The second-type terminal device receives a data signal 1 and a data signal 2. The data signal 1 is sent by a network device to a first-type terminal device but is able to be received by the second-type terminal device, the data signal 2 is sent by the network device to the second-type terminal device, the data signal 1 is an interference signal of the data signal 2, the data signal 1 is transmitted by using a narrow-band beam, and the data signal 2 is transmitted by using a wide-band beam.

For an example of resource mapping between the data signal 1 and the data signal 2 in this scenario, refer to FIG. 6.

To implement the functions in the foregoing embodiments, the terminal device or the network device includes corresponding hardware structures and/or software modules for performing the functions. A person skilled in the art should be easily aware that, in combination with the units and the method steps in the examples described in the at least one embodiment, the at least one embodiment is able to be implemented by using hardware or a combination of hardware and computer software. Whether a function is performed by hardware or hardware driven by computer software depends on particular application scenarios and design constraint conditions of the technical solutions.

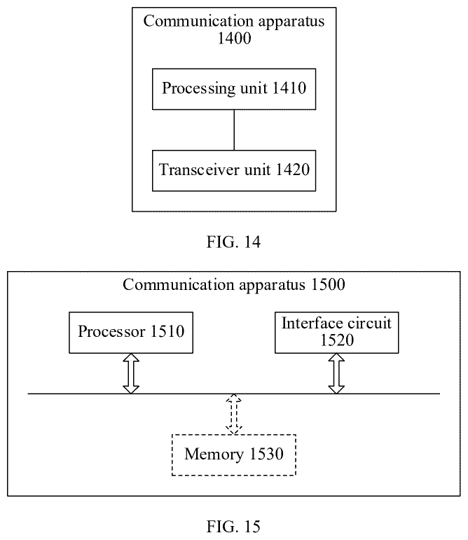

FIG. 14 and FIG. 5 are diagrams of possible structures of communication apparatuses according to at least some embodiments. These communication apparatuses are able to be configured to implement functions of the terminal device or the network device in the foregoing method embodiments. Therefore, beneficial effects of the foregoing method embodiments are also able to be implemented. In at least some embodiments, the communication apparatus are the terminal device or the network device, or a module (for example, a chip) used in the terminal device or the network device.

As shown in FIG. 14, the communication apparatus 1400 includes a processing unit 1410 and a transceiver unit 1420. The communication apparatus 1400 is configured to implement functions of the terminal device or the network device in the foregoing method embodiments.

When the communication apparatus 1400 is configured to implement functions of the first apparatus in the foregoing method embodiments, the transceiver unit 1420 is configured to: receive a first signal, where the first signal includes a second signal and a third signal, and the third signal is a signal that causes interference to the second signal; and receive indication information, where the indication information indicates a resource occupied by the third signal; and the processing unit 1410 is configured to determine the second signal from the first signal based on the indication information.

In at least one embodiment, that the processing unit 1410 is configured to determine the second signal from the first signal based on the indication information specifically includes: determining, based on the indication information, an interference estimation value on the resource occupied by the third signal; and determining the second signal from the first signal based on the interference estimation value.

In at least one embodiment, the indication information indicates a start location and a size of the resource occupied by the third signal.

In at least one embodiment, the indication information includes a PRG start location, a PRG size, and a quantity of PRGs, the PRG start location indicates the start location of the resource occupied by the third signal, and the PRG size and the quantity of PRGs indicate the size of the resource occupied by the third signal.

In at least one embodiment, the indication information includes at least two sets of PRG information, and each set of PRG information includes a PRG start location, a PRG size, and a quantity of PRGs. The PRG start location indicates a start location of a part of the resource occupied by the third signal, and the PRG size and the quantity of PRGs indicate a size of the part of the resource.

In at least one embodiment, the indication information includes a reference point, an offset value, and a resource size, the reference point and the offset value indicate the start location of the resource occupied by the third signal, and the resource size indicates the size of the resource occupied by the third signal.

In at least one embodiment, the indication information is a bitmap, and first information in the bitmap indicates at least one resource element in the resource occupied by the third signal.

In at least one embodiment, the resource occupied by the third signal and a resource occupied by the second signal totally or partially overlap.

In at least one embodiment, the indication information further indicates at least one of the following information:
a port number of the third signal, where the port number indicates a source of the third signal;
a sequence of the third signal; and
scrambling code information of the third signal.

When the communication apparatus 1400 is configured to implement functions of the second apparatus, the third apparatus, and the fourth apparatus in the foregoing method embodiments, the processing unit 1410 is configured to control the transceiver unit 1420 to send a second signal to the terminal device; and send indication information to the terminal device, where the indication information indicates a resource occupied by a third signal that causes interference to the second signal.

In at least one embodiment, the processing unit 1410 is further configured to control the transceiver unit 1420 to send the third signal to the terminal device.

In at least one embodiment, the indication information indicates a start location and a size of the resource occupied by the third signal.

In at least one embodiment, the indication information includes a PRG start location, a PRG size, and a quantity of PRGs, the PRG start location indicates the start location of the resource occupied by the third signal, and the PRG size and the quantity of PRGs indicate the size of the resource occupied by the third signal.

In at least one embodiment, the indication information includes a reference point, an offset value, and a resource size, the reference point and the offset value indicate the start location of the resource occupied by the third signal, and the resource size indicates the size of the resource occupied by the third signal.

In at least one embodiment, the indication information is a bitmap, and first information in the bitmap indicates at least one resource element in the resource occupied by the third signal.

In at least one embodiment, the resource occupied by the third signal and a resource occupied by the second signal totally or partially overlap.

In at least one embodiment, the indication information further indicates at least one of the following information:
a port number of the third signal, where the port number indicates a source of the third signal;
a sequence of the third signal; and
scrambling code information of the third signal.

For more detailed descriptions of the processing unit 1410 and the transceiver unit 1420, directly refer to related descriptions in the foregoing method embodiments. Details are not described herein again.

As shown in FIG. 15, the communication apparatus 1500 includes a processor 1510 and an interface circuit 1520. The processor 1510 and the interface circuit 1520 are coupled to each other. In at least one embodiment, the interface circuit 1520 is a transceiver or an input/output interface. In at least one embodiment, the communication apparatus 1500 further includes a memory 1530, configured to: store instructions executed by the processor 1510, store input data that the processor 1510 needs to run the instructions, or store data generated after the processor 1510 runs the instructions.

When the communication apparatus 1500 is configured to implement the foregoing method embodiments, the processor 1510 is configured to implement a function of the processing unit 1410, and the interface circuit 1520 is configured to implement a function of the transceiver unit 1420.

In at least some embodiments, the processor is a central processing unit (Central Processing Unit, CPU), or another general-purpose processor, a digital signal processor (Digital Signal Processor, DSP), an application-specific integrated circuit (Application-Specific Integrated Circuit, ASIC), a field programmable gate array (Field Programmable Gate Array, FPGA) or another programmable logic device, a transistor logic device, a hardware component, or any combination thereof. In at least one embodiment, the processor is a microprocessor, or any conventional processor.

The method steps in at least some embodiments are implemented in a hardware manner, or implemented in a manner of executing software instructions by the processor. In at least one embodiment, the software instructions include a corresponding software module. In at least one embodiment, the software module is stored in a random access memory, a flash memory, a read-only memory, a programmable read-only memory, an erasable programmable read-only memory, an electrically erasable programmable read-only memory, a register, a hard disk, a removable hard disk, a compact disc read-only memory (compact disc read-only memory, CD-ROM), or any other form of storage medium well-known in the art. For example, a storage medium is coupled to the processor, so that the processor is able to read information from the storage medium and write information into the storage medium. In at least one embodiment, the storage medium is a component of the processor. In at least one embodiment, the processor and the storage medium are disposed in the ASIC. In addition, in at least one embodiment, the ASIC is located in the terminal device or the network device. In at least one embodiment, the processor and the storage medium exist in an access network device or a terminal as discrete components.

All or a part of the foregoing embodiments are able to be implemented by using software, hardware, firmware, or any combination thereof. When the software is used for implementation, all or a part of embodiments are able to be implemented in a form of a computer program product. The computer program product includes one or more computer programs or instructions. The computer program (English: Computer Program) is a set of instructions that instruct each step of an electronic computer or another device having a message processing capability, is usually written in a program design language, and is run in a target architecture. When the computer programs or the instructions are loaded and executed on a computer, all or a part of the procedures or functions in at least some embodiments are executed. In at least one embodiment, the computer is a general-purpose computer, a dedicated computer, a computer network, or another programmable apparatus. In at least one embodiment, the computer program or the instructions is stored in a computer-readable storage medium, or is transmitted from a computer-readable storage medium to another computer-readable storage medium. For example, in at least one embodiment, the computer program or the instructions is transmitted from a website, computer, server, or data center to another website, computer, server, or data center in a wired or wireless manner. In at least one embodiment, the computer-readable storage medium is any usable medium that is able to be accessed by the computer, or a data storage device, for example, a server or a data center, integrating one or more usable media. In at least one embodiment, the usable medium is a magnetic medium, for example, a floppy disk, a hard disk, or a magnetic tape; or is an optical medium, for example, a digital video disc; or is a semiconductor medium, for example, a solid-state drive. In at least one embodiment, the computer-readable storage medium is a volatile or non-volatile storage medium, or includes two types of storage media: a volatile storage medium and a non-volatile storage medium.

In at least some embodiments, unless otherwise stated or there is a logic conflict, terms and/or descriptions in different embodiments are consistent and are able to be mutually referenced, and technical features in different embodiments are able to be combined based on an internal logical relationship thereof, to form a new embodiment.

In the present disclosure, “at least one” means one or more, and “a plurality of” means two or more. “And/or” describes an association relationship between associated objects, and represents that three relationships are able to exist. For example, A and/or B is able to represent the following cases: Only A exists, both A and B exist, and only B exists, where A and B are able to be singular or plural. In the text descriptions of the present disclosure, the character “/” generally represents an “or” relationship between the associated objects. In a formula in the present disclosure, the character “/” represents a “division” relationship between the associated objects.

Various numbers in at least some embodiments of the present disclosure are merely used for differentiation for ease of description, and are not used to limit the scope of embodiments of the present disclosure. Sequence numbers of the foregoing processes do not mean an execution sequence, and the execution sequence of the processes should be determined based on functions and internal logic of the processes.

What claimed is:

1. A communication method, comprising:
receiving a first signal, wherein the first signal comprises a second signal and a third signal, and the third signal is a signal that causes interference to the second signal;
receiving indication information, wherein the indication information indicates a resource occupied by the third signal; and
determining the second signal from the first signal based on the indication information.

2. The method according to claim 1, wherein the determining the second signal from the first signal based on the indication information comprises:
determining, based on the indication information, an interference estimation value on the resource occupied by the third signal; and
determining the second signal from the first signal based on the interference estimation value.

3. The method according to claim 1, wherein the indication information indicates a start location and a size of the resource occupied by the third signal.

4. The method according to claim 3, wherein the indication information comprises a reference point, an offset value, and a resource size, the reference point and the offset value indicate the start location of the resource occupied by the third signal, and the resource size indicates the size of the resource occupied by the third signal.

5. The method according to claim 3, wherein the indication information comprises a precoding resource block group (PRG) start location, a PRG size, and a quantity of PRGs, the PRG start location indicates the start location of the resource occupied by the third signal, and the PRG size and the quantity of PRGs indicate the size of the resource occupied by the third signal.

6. The method according to claim 1, wherein the indication information is a bitmap, and first information in the bitmap indicates at least one resource element in the resource occupied by the third signal.

7. The method according to claim 1, wherein the resource occupied by the third signal and a resource occupied by the second signal totally or partially overlap.

8. A communication method, comprising:
sending a second signal to a terminal device; and
sending indication information to the terminal device, wherein the indication information indicates a resource occupied by a third signal that causes interference to the second signal.

9. The method according to claim 8, wherein the method further comprises:
sending the third signal to the terminal device.

10. The method according to claim 8, wherein the indication information indicates a start location and a size of the resource occupied by the third signal.

11. The method according to claim 10, wherein the indication information comprises a reference point, an offset value, and a resource size, the reference point and the offset value indicate the start location of the resource occupied by the third signal, and the resource size indicates the size of the resource occupied by the third signal.

12. The method according to claim 10, wherein the indication information comprises a precoding resource block group PRG start location, a PRG size, and a quantity of PRGs, the PRG start location indicates the start location of the resource occupied by the third signal, and the PRG size and the quantity of PRGs indicate the size of the resource occupied by the third signal.

13. The method according to claim 8, wherein the indication information is a bitmap, and first information in the bitmap indicates at least one resource element in the resource occupied by the third signal.

14. The method according to claim 8, wherein the resource occupied by the third signal and a resource occupied by the second signal totally or partially overlap.

15. A communication apparatus, comprising at least one processor, and one or more memories coupled to the at least one processor and storing programming instructions for execution by the at least one processor, to enable the communication apparatus to:
receive a first signal, wherein the first signal comprises a second signal and a third signal, and the third signal is a signal that causes interference to the second signal;
receive indication information, wherein the indication information indicates a resource occupied by the third signal; and
determine the second signal from the first signal based on the indication information.

16. The communication apparatus according to claim 15, wherein the determine the second signal from the first signal based on the indication information comprises:
determine, based on the indication information, an interference estimation value on the resource occupied by the third signal; and
determine the second signal from the first signal based on the interference estimation value.

17. The communication apparatus according to claim 15, wherein the indication information indicates a start location and a size of the resource occupied by the third signal.

18. The communication apparatus according to claim 17, wherein the indication information comprises a reference point, an offset value, and a resource size, the reference point and the offset value indicate the start location of the resource occupied by the third signal, and the resource size indicates the size of the resource occupied by the third signal.

19. The communication apparatus according to claim 17, wherein the indication information comprises a precoding resource block group (PRG) start location, a PRG size, and a quantity of PRGs, the PRG start location indicates the start location of the resource occupied by the third signal, and the PRG size and the quantity of PRGs indicate the size of the resource occupied by the third signal.

20. The communication apparatus according to claim 15, wherein the indication information is a bitmap, and first information in the bitmap indicates at least one resource element in the resource occupied by the third signal.
